(19) United States
(12) Patent Application Publication
(10) Pub. No.: US 2014/0106163 A1
(43) Pub. Date: Apr. 17, 2014

(54) OPTICAL ARTICLE INCLUDING AN ANTIREFLECTION COATING HAVING IMPROVED CRACK-RESISTANCE PROPERTIES UNDER MECHANICAL STRESS

(71) Applicant: ESSILOR INTERNATIONAL (COMPAGNIE GENERALE D'OPTIQUE), Charenton Le Pont (FR)

(72) Inventors: Peggy Coue, Charenton Le Pont (FR); Amelie Kudla, Charenton Le Pont (FR); Isabelle Bonnet, Charenton Le Pont (FR)

(73) Assignee: ESSILOR INTERNATIONAL (COMPAGNIE GENERALE D'OPTIQUE), Charenton Le Pont (FR)

(21) Appl. No.: 14/134,479

(22) Filed: Dec. 19, 2013

Related U.S. Application Data
(63) Continuation-in-part of application No. PCT/FR2012/051500, filed on Jun. 28, 2012.

(30) Foreign Application Priority Data
Jul. 1, 2011 (FR) 1155955

(51) Int. Cl. G02B 1/11

(52) U.S. Cl. CPC G02B 1/111
USPC 428/331; 428/425.5; 428/336; 427/165

(57) ABSTRACT

The invention relates to an optical article including a transparent organic glass substrate, a primary coating including polyurethane and particulate silica, an abrasion-resistant coating, and an antireflection coating, said coatings, and in particular the antireflection coating, having improved crack resistance when the optical article is subjected to high amounts of mechanical stress, e.g., during edge-grinding and the mounting of lenses in eyeglass frames. The invention also relates to a method for manufacturing such an article.

### CROSS-REFERENCE TO RELATED APPLICATIONS

This application is a continuation-in-part of International Patent Application No. PCT/FR2012/051500, filed Jun. 28, 2012, published as WO 2013/004954, and claiming priority to FR 11 55955, filed Jul. 1, 2011.

The foregoing applications, and all documents cited therein or during their prosecution (“appln cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

The present invention relates to an optical article, preferably an ophthalmic lens, comprising a transparent substrate made of organic glass, a primer coating comprising polyurethane and particulate silica, an abrasion-resistant coating and an antireflective coating, which coatings, in particular the antireflective coating, have an improved crack resistance when the optical article is subjected to high mechanical stresses, such as, for example, during stages of edging and mounting glasses in spectacle frames. The invention also relates to a process for the manufacture of such an article.

### BACKGROUND

In the field of ophthalmic optics, it is conventional to coat an ophthalmic lens with various coatings in order to confer, on this lens, various mechanical and/or optical properties.

Thus, a primer coating, an abrasion-resistant coating and an antireflective coating can be successively applied to an ophthalmic lens (also known as substrate).

The primer coating makes it possible to improve the impact strength of the subsequent layers in the final product. In addition, it makes it possible to ensure good adhesion of the abrasion-resistant coating to the substrate. In the present invention, the primer compositions are based on polyurethane latex.

The abrasion-resistant coating, as is indicated by its name, has the role of protecting the ophthalmic lens from scratches and abrasion.

The antireflective coating makes it possible to improve the antireflective properties of the final optical article. It makes it possible to reduce the reflection of light at the article/air interface over a relatively broad portion of the visible spectrum.

Unless otherwise indicated, the refractive indices to which reference is made in the present invention are expressed at 25° C. for a wavelength of 550 nm.

One of the problems encountered with the antireflective coatings is their lack of strength during stages of edging and mounting glasses in spectacle frames. The primer/abrasion-resistant/antireflective coating system is then subjected to high mechanical stresses, resulting in the deformation, as far as cracking, of the antireflective layers. According to the stack, the crack can propagate into the abrasion-resistant coating, indeed even into the primer coating.

### SUMMARY OF THE INVENTION

The invention provides for an optical article comprising, in the following order, starting from the substrate:

(a) a transparent substrate made of organic glass comprising two main faces,

(b) a primer coating comprising polyurethane, deposited on at least one of the two main faces of the substrate made of glass,

(c) an abrasion-resistant coating deposited on the primer coating, and

(d) an antireflective coating deposited on the abrasion-resistant coating, wherein the primer coating additionally comprises particulate silica.

The invention also provides for a process for the manufacture of an optical article comprising the following stages:

(1) providing a substrate made of glass comprising two main faces;

(2) depositing, on at least one of the two main faces, a layer of a liquid primer composition comprising a polyurethane dispersion and colloidal silica, and then curing said primer composition, so as to obtain a primer coating;

(3) depositing an abrasion-resistant coating on the primer coating;

(4) depositing an antireflective coating on the abrasion-resistant coating.

In a further embodiment, the invention additionally provides for a method for enhancing the crack resistance of an antireflective coating in an optical article comprising, in the following order, starting from the substrate:

(a) a substrate made of glass comprising two main faces,

(b) a primer coating comprising polyurethane, deposited on at least one of the two main faces of the substrate made of glass,

(c) an abrasion-resistant coating deposited on the primer coating, and

(d) an antireflective coating deposited on the abrasion-resistant coating,

when said optical article is subjected to mechanical stresses,

which comprises introducing particulate silica into said primer coating.

### BRIEF DESCRIPTION OF THE DRAWINGS

The following detailed description, given by way of example, but not intended to limit the invention solely to the specific embodiments described, may best be understood in conjunction with the accompanying drawings.

FIG. 1 represents the increase in crack resistance of an antireflective coating, deposited on an abrasion-resistant coating (3.5 μm), itself deposited on a primer coating (0.8 μm) comprising polyurethane and particulate silica (Cataloid Si30® or Bindzil CC40®), itself deposited on a substrate made of CR39®, as a function of the ratio between the silica/polyurethane proportions by volume in the dry primer coating.

FIG. 2 represents the increase in crack resistance of an antireflective coating, deposited on an abrasion-resistant coating (3.5 μm), itself deposited on a primer coating (0.8 μm) comprising polyurethane and particulate silica (Bindzil CC40®), itself deposited on a substrate made of MR7®, as a function of the ratio between the silica/polyurethane proportions by volume in the dry primer coating.

FIG. 3 represents the impact strength of the antireflective coating as a function of the proportion of particulate silica in the primer coating (substrate: CR39; primer coating comprising polyurethane and Cataloid Si30® particulate silica; abrasion-resistant layer having a polysiloxane matrix comprising colloidal silica; antireflective layer: coating similar to Crizal Alizé® with additional presence of an ITO antistatic layer).

FIG. 4 represents the crack resistance of the antireflective coating as a function of the proportion of particulate silica in the primer coating (substrate: MR7; primer coating comprising polyurethane and Cataloid Si30® particulate silica; abrasion-resistant layer having a polysiloxane matrix comprising colloidal silica; antireflective layer: Crizal Forte®).

### DETAILED DESCRIPTION

It is an objective of the present invention to improve the crack resistance of the various coatings applied to the ophthalmic lens and in particular of the antireflective coating when the lens is subjected to high mechanical stresses, such as, for example, during stages of edging and mounting glasses in spectacle frames.

This objective is achieved by modifying the composition of the primer coating.

This is because the inventors have discovered that, when particulate silica is incorporated in the polyurethane-based primer coating, the antireflective coating becomes more resistant to the formation of cracks during high mechanical stresses.

A subject matter of the present invention is thus an optical article comprising, in the following order, starting from the substrate:

(a) a transparent substrate made of organic glass comprising two main faces,

(b) a primer coating comprising polyurethane, deposited on at least one of the two main faces of the substrate made of organic glass,

(c) an abrasion-resistant coating deposited on the primer coating, and

(d) an antireflective coating deposited on the abrasion-resistant coating, characterized in that the primer coating additionally comprises particulate silica.

As shown in the examples described below, the presence of at least 20% by weight of particulate silica in the dry primer coating makes it possible to obtain an increase in the crack resistance of the antireflective coating, evaluated according to the test described below, of at least 10%, on average of 15%, indeed even up to 28%, with respect to the same coating devoid of silica.

Furthermore, the presence of particulate silica in the primer coating does not detrimentally affect either the adhesion or the abrasion resistance of the abrasion-resistant coating.

The inventors have observed that the impact strength of the antireflective coating could decrease as the amount of particulate silica in the primer coating is increased. The best compromise in performance between the crack resistance of the antireflective coating and the impact strength according to the ball drop (BAD) test described below can be obtained with a percentage by weight of particulate silica preferably of between 20% and 55%, more preferably still between 25% and 55%, in particular between 25% and 30%, or in the vicinity of 50%, for example between 45% and 55%, with respect to the weight of dry coating.

The expression “primer coating deposited on at least one of the two main faces of the substrate” means that the primer coating (i) is positioned on at least one of the two faces of the substrate, (ii) is not necessarily in contact with the substrate, that is to say that one or more intermediate coatings may be positioned between the substrate and the primer coating, and (iii) does not necessarily completely cover the substrate, complete covering being, however, preferential.

The expression “abrasion-resistant coating deposited on the primer coating” means that the abrasion-resistant coating (i) is positioned on the uncovered surface of the primer coating, that is to say the face furthest from the substrate, (ii) is not necessarily in contact with the primer coating, that is to say that one or more intermediate coatings may be positioned between the primer coating and the abrasion-resistant coating, and (iii) does not necessarily completely cover the primer coating, complete covering being, however, preferential.

In the same way, the expression “antireflective coating deposited on the abrasion-resistant coating” means that the antireflective coating (i) is positioned on the uncovered surface of the abrasion-resistant coating, that is to say the face furthest from the substrate, (ii) is not necessarily in contact with the abrasion-resistant coating, that is to say that one or more intermediate coatings may be positioned between the abrasion-resistant coating and the antireflective coating, and (iii) does not necessarily completely cover the abrasion-resistant coating, complete covering being, however, preferential.

The transparent substrate made of organic glass of the optical article of the present invention can be any substrate commonly used in the field of optics and in particular in the ophthalmic field. It is, for example, composed of a thermoplastic or thermosetting plastic.

Mention may be made, by way of examples, of substrates made of polycarbonate, of polyamide, of polyimide, of polysulfone, of copolymers of poly(ethylene terephthalate) and polycarbonate, of polyolefins, in particular of polynorbornene, of homopolymers and copolymers of diethylene glycol bis(allyl carbonate), of (meth)acrylic polymers and copolymers, in particular (meth)acrylic polymers and copolymers derived from bisphenol A, of thio(meth)acrylic polymers and copolymers, of polyurethane and polythiourethane homopolymers or copolymers, epoxy polymers and copolymers and episulfide polymers and copolymers.

For example, it will be possible to use a diethylene glycol bis(allyl carbonate), such as CR39®, in particular with a refractive index of 1.5, sold by PPG Industries, or else a polythiourethane, such as MR7®, in particular with a refractive index of 1.66, sold by Mitsui Toatsu.

The substrate made of organic glass preferably has a refractive index of 1.5. However, a substrate with a refractive index different from 1.5 can also be used in the present invention by employing a quarter-wave plate as described in the application WO 03/056366.

The organic substrate can be subjected, before application or being brought into contact with the adhesive layer, to a physical surface treatment, for example of corona or plasma type or chemical type, generally intended to improve the adhesion.

The primer coating deposited on at least one of the two main faces of the substrate comprises polyurethane and particulate silica.

The term “particulate silica” is understood to mean silica which is provided in the form of essentially individualized particles not agglomerated with one another. Typically, the particulate silica according to the present invention originates from commercially available dispersions of colloidal silica.

The primer coating can be deposited on the substrate in the following way:
(1) on the substrate, application of a liquid primer composition comprising a polyurethane latex and particulate silica;
(2) drying the substrate obtained in stage (1) at a temperature of between 50° C. and 150° C., preferably between 70° C. and 110° C., for a period of time of between 2 minutes and 4 hours, preferably between 10 minutes and 3.5 hours.

After the drying stage, the thickness of the primer coating is between 0.2 and 2.5 μm, preferably between 0.5 and 1.5 μm and more preferably still between 0.5 and 1 μm.

In stage (1), the primer composition can be deposited on the surface of the substrate by any appropriate technique, for example by dipping, centrifuging, spraying, sprinkling or application with a brush or roller, preferably by dipping.

The drying stage (2) can be carried out in two phases: a precuring phase at a temperature of between 70 and 80° C., preferably at approximately 75° C., for a period of time of between 10 and 20 minutes, preferably approximately 15 minutes, followed by a polymerization phase at a temperature of between 90 and 110° C., preferably at approximately 100° C., for a period of time of between 2.5 hours and 3.5 hours, preferably approximately 3 hours.

The term “dry coating” is understood to mean the coating obtained after drying or curing.

The percentage by weight of polyurethane in the dry primer coating is preferably between 30% and 80%, preferably between 35% and 65%, between 20% and 55% or between 25% and 55%, more preferably between 45% and 55% or else between 25% and 30%, with respect to the weight of dry coating.

The percentage by weight of particulate silica in the dry primer coating is preferably between 20% and 70%, preferably between 35% and 65% and more preferably between 45% and 55%, with respect to the weight of dry coating.

The ratio by weight of the particulate silica to the polyurethane in the dry primer coating can thus be between 0.2 and 2.5, preferably between 0.5 and 1.5 and more preferably between 0.9 and 1.1.

The percentage by volume of polyurethane in the dry primer coating is preferably between 50% and 90%, preferably between 60% and 80% and more preferably between 65% and 75%, with respect to the volume of dry coating.

The percentage by volume of particulate silica in the dry primer coating is preferably between 10% and 50%, preferably between 20% and 40%, between 10% and 35% or between 12% and 35%, more preferably between 25% and 35% or else between 12% and 15%, with respect to the volume of dry coating.

The ratio by volume of the particulate silica to the polyurethane in the dry primer coating can thus be between 0.1 and 1.0, preferably between 0.25 and 0.70 and more preferably between 0.35 and 0.50.

The thickness of the dry primer coating is between 0.2 and 2.5 μm, preferably between 0.5 and 1.5 μm and more preferably still between 0.5 and 1 μm.

In the dry primer coating, the colloidal silica preferably exhibits a mean particle size of between 5 nm and 50 nm, more preferably between 5 nm and 15 nm and more preferably still between 7 nm and 12 nm. The size of the particles is typically determined by transmission electron microscopy (TEM).

The liquid primer composition comprises, in an aqueous medium, polyurethane in the form of a dispersion and colloidal silica. The aqueous medium predominantly comprises water, for example distilled water or deionized water, but can also comprise, in a small amount, one or more solvents originating, for example, from the polyurethane latexes or from the colloidal silicas which are used to prepare the liquid primer composition.

As indicated above, the mean size of the particles is preferably between 5 nm and 50 nm, more preferably between 5 nm and 15 nm and more preferably still between 7 nm and 12 nm. When the silica is in the form of a dispersion, the size of the silica particles is typically measured by laser particle sizing.

The solids content of the liquid primer composition is preferably between 13% and 20% by weight.

The percentage by weight of silica in the primer composition can be between 3% and 14% or also between 6% and 11%.

The percentage by weight of polyurethane in the primer composition can be between 6% and 17% or also between 9% and 14%.

Preferably, the percentage by weight of polyurethane in the primer composition is greater than or equal to 6%, more preferably still greater than or equal to 7%.

The primer composition can additionally comprise a surfactant.

The polyurethane of the primer composition is chosen from polyurethane latexes.

Within the meaning of the present invention, a latex is a dispersion in an aqueous medium of particles of polymer or copolymer. The aqueous medium can be water, for example distilled water or deionized water, or also a mixture of water and one or more solvents, in particular of water and alkanol, generally a C₁ to C₆ alkanol, preferably ethanol.

In the present invention, the term “polyurethane” encompasses both polyurethane (co)polymers proper, that is to say the polymers obtained by condensation of at least one polyisocyanate and of at least one polyol and optionally of a chain extender, and polyurethane-ureas, that is to say the (co)polymers obtained by condensation of at least one polyisocyanate and of at least one polyamine and optionally of a chain extender, and blends of these.

The polyurethanes and their method of preparation are described, inter alia, in the patents U.S. Pat. No. 6,187,444 and U.S. Pat. No. 5,316,791.

Preferably, the polyurethanes of the invention do not comprise acrylic or methacrylic functional groups and in particular do not comprise a polymerizable acrylic or methacrylic functional group.

The polyurethane latex can also comprise a low proportion, up to 10% by weight of the composition, of a (meth)acrylic latex, preferably of an acrylic latex, such as described in the application WO 00/08493. Preferably, the proportion by weight of (meth)acrylic latex varies from 0.1% to 10% by weight and better still from 2% to 6% by weight, with respect to the total weight of the latex composition. The proportion by weight on a dry basis of the acrylic latex with respect to the total weight on a dry basis of the composition also preferably varies from 0.1% to 10% by weight and better still from 2% to 6% by weight. The presence of (meth)acrylic latex has the advantage, on the one hand, of decreasing the hydrophilic nature of the material and, on the other hand, of rendering the dry final layer more rigid and of reducing its elongation at break. These (meth)acrylic latexes are commercially available, in particular from Syntron under the names Proxam 185 RS® (acrylic resin), Proxam 157® (acrylic copolymer) and Proxam N 360® (acrylic copolymer).

The polyurethane latex can also comprise a low proportion, up to 10% by weight of the composition, of latex comprising butadiene units, such as those described in the application WO 99/26089.

The polyurethane latexes suitable for the present invention are commercially available, for example from Baxenden under the names W 234 and W 240 (polyurethane-urea), or under the name Pellimer TC® (polyurethane-urea) from Socomor and the name Proxr 910® (polyurethane) from Syntron.

The primer composition preferably comprises a polyurethane latex sold by Baxenden under the name W 234. This latex is a dispersion of polyurethane of anionic aliphatic polyester type devoid of free isocyanate. Its pH at 25° C. is between 7.5 and 9.2. Its solids content is between 29% and 31%. Its viscosity at 25° C. is 100 cPs. Its density at 25° C. is 1.05.

The polyurethane latex compositions according to the invention can very obviously be blends of polyurethane latexes, in particular of commercial polyurethane latexes.

As mentioned above, the particulate silica incorporated in the primer composition is preferably a colloidal silica, that is to say a silica in the form of fine particles in suspension in a liquid medium, preferably an aqueous medium.

These aqueous suspensions of colloidal silica comprise or are composed of fine individualized silica particles, not bonded to one another via siloxane bonds, in suspension in water and are preferably substantially devoid of aggregates of particles.

The mean size of the silica particles is preferably between 5 nm and 50 nm, more preferably between 5 nm and 15 nm and more preferably still between 7 nm and 12 nm. The surface of the silica particles can be positively or negatively charged, preferably negatively charged when in particular the polyurethane is of anionic type. In addition, the surface of the silica particles can be modified by grafting functional groups, such as amine, thiol or epoxy groups.

Preferably, the colloidal silica is of basic pH between 7 and 11, more preferably still between 8 and 10.

The colloidal silica which is incorporated in the primer composition can comprise between 20% and 50% by weight of silica, preferably between 25% and 35% by weight of silica.

The colloidal silica suitable for the preparation of the primer composition according to the invention is commercially available, for example from JGC under the name Cataloid SI30, from Eka Chemicals under the name Bindzil CC40 or else from Grace Davison under the name Ludox SM 30.

The primer composition can be prepared by mixing, with stirring, the polyurethane in the form of an aqueous dispersion with the colloidal silica and the distilled or deionized water.

The ratio by volume of the colloidal silica to the polyurethane dispersion is determined so as to achieve the desired solids content.

The surfactant can be incorporated in the composition before carrying out the polyurethane/silica mixing or else after having carried out the mixing.

According to the present invention, an abrasion-resistant coating is deposited on the primer coating. The abrasion-resistant coating can be any layer conventionally used as abrasion-resistant coating in the field of ophthalmic lenses.

Hard abrasion-resistant and/or scratch-resistant coatings are preferably prepared from compositions comprising at least one alkoxysilane and/or one hydrolyzate of the latter obtained, for example, by hydrolysis with a hydrochloric acid solution. After the hydrolysis stage, the duration of which is generally between 2 h and 24 h, preferably between 2 h and 6 h, catalysts can optionally be added. A surface-active compound is preferably also added in order to promote the optical quality of the deposit.

Mention may be made, among the coatings recommended in the present invention, of coatings based on epoxysilane hydrolyzates, such as those described in the patents EP 0 614 957, U.S. Pat. No. 4,211,823 and U.S. Pat. No. 5,015,523.

A preferred composition for an abrasion-resistant coating is that disclosed in the patent FR 2 702 486 on behalf of the applicant. It comprises an epoxytrialkoxysilane and dialkyldialkoxysilane hydrolyzate, colloidal silica and a catalytic amount of aluminum-based curing catalyst, such as aluminum acetylacetonate, the remainder being essentially composed of solvents conventionally used for the formulation of such compositions. Preferentially, the hydrolyzate used is a γ-glycidoxypropyltrimethoxysilane (GLYMO) and dimethyldiethoxysilane (DMDES) hydrolyzate or else a γ-glycidoxypropyltrimethoxysilane (GLYMO) and triethyl orthosilicate (TEOS) hydrolyzate.

The abrasion-resistant coating composition can be deposited on the free surface of the primer coating by any appropriate technique, for example by dipping, centrifuging, spraying, sprinkling or application with a brush or roller, preferably by dipping or centrifuging. It is subsequently cured by the appropriate route (preferably thermal or UV radiation).

The thickness of the abrasion-resistant coating generally varies from 2 to 10 μm, preferably from 3 to 5 μm.

According to the present invention, an antireflective coating is deposited on the abrasion-resistant coating.

Antireflective coatings are well known and conventionally comprise a single-layer or multilayer stack of dielectric materials, such as SiO, SiO₂, Al₂O₃, MgF₂, LiF, Si₃N₄, TiO₂, ZrO₂, Nb₂O₅, Y₂O₃, HfO₂, Sc₂O₃, Ta₂O₅, Pr₂O₃ or their mixtures.

As is also well known, antireflective coatings are preferably multilayer coatings alternately comprising layers of high refractive index and layers of low refractive index.

In the present patent application, a layer of the multilayer stack of the antireflective (AR) coating is said to be a layer of high refractive index (HI) when its refractive index is greater than or equal to 1.6, preferably greater than or equal to 1.7, better still greater than or equal to 1.8 and even better still greater than or equal to 1.9. A layer of the multilayer stack of the antireflective coating is said to be a layer of low refractive index (LI) when its refractive index is less than or equal to 1.54, preferably less than or equal to 1.52 and better still less than or equal to 1.50.

The antireflective coatings suitable for the invention are, for example, the Crizal Alizé® and Crizal Forte® coatings sold by the applicant company and described in the applications WO 2004/111691 and WO 2008/107325.

The various layers of the multilayer stack are preferably deposited by vacuum deposition according to one of the following techniques: i) by evaporation, optionally ion beam-assisted evaporation, ii) by ion beam sputtering, iii) by cathode sputtering or iv) by plasma-enhanced chemical vapor deposition. These different techniques are described in the works “Thin Film Processes” and “Thin Film Processes II”, edited by Vossen and Kern, Academic Press, 1978 and 1991 respectively. A technique which is particularly recommended is the vacuum evaporation technique.

Generally, the HI layers have a thickness varying from 10 nm to 120 nm and the LI layers have a physical thickness varying from 10 nm to 100 nm.

Preferably, the total thickness of the antireflective coating is less than 1 μm, better still less than or equal to 500 nm and even better still less than or equal to 250 nm. The total thickness of the antireflective coating is generally greater than 100 nm, preferably greater than 150 nm.

Another subject matter of the present invention is a process for the manufacture of an optical article, preferably an ophthalmic lens, comprising the following stages:
(1) providing a transparent substrate made of organic glass comprising two main faces;
(2) depositing, on at least one of the two main faces, a layer of a liquid primer composition comprising a polyurethane dispersion and colloidal silica, and then curing said primer composition, so as to obtain a primer coating;
(3) depositing an abrasion-resistant coating on the primer coating;
(4) depositing an antireflective coating on the abrasion-resistant coating.

Another subject matter of the present invention is an optical article capable of being obtained according to the process as defined above.

The optical article according to the present invention preferably exhibits a refractive index of 1.5.

Another subject matter of the present invention is the use of particulate silica in an optical article comprising, in the following order, starting from the substrate:
(a) a transparent substrate made of organic glass comprising two main faces,
(b) primer coating comprising polyurethane, deposited on at least one of the two main faces of the substrate made of glass,
(c) an abrasion-resistant coating deposited on the primer coating, and
(d) an antireflective coating deposited on the abrasion-resistant coating, for enhancing the crack resistance of the antireflective coating when said optical article is subjected to mechanical stresses, characterized in that said particulate silica is introduced into said primer coating.

Another subject matter of the present invention is a process for increasing the crack resistance of an antireflective coating on an optical article when the latter is subjected to mechanical stresses, said optical article comprising, in the following order, starting from the substrate:
(a) a transparent substrate made of organic glass comprising two main faces,
(b) a primer coating comprising polyurethane, deposited on at least one of the two main faces of the substrate made of glass,
(c) an abrasion-resistant coating deposited on the primer coating, and
(d) said antireflective coating deposited on the abrasion-resistant coating, characterized in that said process comprises the stage consisting in incorporating particulate silica in said primer coating.

In the present invention, the crack resistance of the antireflective coating during high mechanical stress is evaluated in the following way.

A compressive load of 50 daN is applied, at ambient temperature, at the center of the lens for 10 seconds. After examining the surface of the lens for possible cracks, the application of a compressive load is restarted with a nominal value greater by 5 daN than that applied previously. This cycle is repeated until cracks appear in the antireflective coating. The critical load is the lowest load for which cracks were observed.

The increase in crack resistance of the antireflective coating of the tested article, in comparison with a reference article, is calculated according to the following formula: Increase=(critical load of the tested article−critical load of the reference article)/critical load of the reference article.

### EXAMPLES

### 1) Crack Resistance

1.1) Preparation of the Primer Composition

A primer composition is prepared from the following ingredients and in the following proportions:

| | | Solids content | % by |
|---|---|---|---|
| | Name | (% by weight) | weight |
| Colloidal silica | Cataloid Si30 ® (supplier: | 30% | 29.6 |
| | JCG) | | |
| | Mean particle size: 12 nm | | |
| Aqueous | Dilution of W234 ® | 15% | 65.8 |
| polyurethane | (supplier: Baxenden | | |
| dispersion | Chemicals) | | |
| Surfactant | L77 ® | 100% | 0.5 |
| | (supplier: Grolman) | | |
| Distilled water | — | | 4.1 |

Half the distilled water is added to the colloidal silica and the mixture is stirred for 30 minutes. The latex dispersion is slowly added to this mixture and then the surfactant and the second half of the water are added. The composition is stirred for 1 hour and then stored at a temperature of 5° C.

In the dry coating, the ratio by volume of the colloidal silica to the polyurethane dispersion is 30/70.

According to the same procedure and starting from the same ingredients, two other primer compositions are prepared which differ from the composition described above only in that the ratio by volume of the colloidal silica to the polyurethane dispersion in the dry coating is 37/63 and 43/57 respectively.

According to the same protocol, three other primer compositions are prepared which differ from the three preceding ones only in that the Cataloid Si30® colloidal silica is replaced with a silica having the name Bindzil CC40® (supplier: Eka Chemicals) with a mean particle size: 12 nm.

1.2) Preparation of Ophthalmic Lenses According to the Invention

Stage (A)—Substrate

Two types of organic glasses are used:
(a) a glass made of diethylene glycol bis(allyl carbonate) having a refractive index of 1.5, resin sold by PPG under the name CR39®,
(b) a glass made of polythiourethane having a refractive index of 1.66, resin sold by Mitsui under the name MR7®.

All the glasses are subjected to a surface chemical treatment.

Each glass batch is separated into two series, one intended to receive, in accordance with the invention, a primer coating based on polyurethane and particulate silica covered with an abrasion-resistant coating and an antireflective coating and the other intended to receive the same coating based on polyurethane but devoid of silica, the same abrasion-resistant coating and the same antireflective coating (comparative glasses according to the state of the art).

Stage (B)—Deposition of a Primer Coating

The primer coating is deposited by immersion (dip coating) on both faces of the glass at a thickness of approximately 0.8 μm. This layer is subsequently subjected to drying at 75° C. for 15 minutes.

Stage (C)—Deposition of an Abrasion-Resistant Coating

A thermosetting solution for an abrasion-resistant coating (comprising, with respect to the total weight of the composition, 22% of glycidoxypropylmethyldimethoxysilane, 62% of colloidal silica present at 30% in methanol, and 0.70% of aluminum acetylacetonate) is deposited on both surfaces of the primer coating by immersion (dip coating) in a thickness of approximately 3.5 μm. This layer is subsequently subjected to crosslinking by heating at 100° C. for 3 hours. The thermosetting solution and the process for obtaining the abrasion-resistant coating are described in Example 3 of the patent EP 0 614 957 B1.

Stage (D)—Deposition of a Multilayer Antireflective Coating

A Crizal Alizé antireflective coating, which is described in particular in the patent application WO 2004/111691, is deposited at the surface of the abrasion-resistant coating.

1.3) Preparation of Comparative Ophthalmic Lenses

A primer coating, an abrasion-resistant coating and an antireflective coating are successively deposited by immersion (dip coating) on the substrates described above (made of CR39 and MR7®) under conditions strictly identical to those used for the lenses according to the invention, so that the comparative lenses differ from the lenses according to the invention only in that the primer coating does not comprise silica.

1.4) Test for Evaluating the Crack Resistance of the Antireflective Coating During High Mechanical Stress

1.4.1) Method:

A compressive load of 50 daN is applied, at ambient temperature, at the center of the lens for 10 seconds. After examining the surface of the lens for possible cracks, the application of a compressive load is restarted with a nominal value greater by 5 daN than that applied previously. This cycle is repeated until cracks appear in the antireflective coating. The critical load is the lowest load for which cracks were observed.

For the critical load, 6 glasses are tested for the mean indicated below. The differences obtained are significantly greater than the uncertainty in reproducibility of the test.

1.4.2) Results:

The results of the test carried out on an ophthalmic lens with substrate made of CR39® and Crizal Alizé® antireflective coating are shown in table 1:

TABLE 1

| | Primer coating | | | Increase in |
|---|---|---|---|---|
| | | Ratio between the | | resistance |
| | | silica/polyurethane | | with |
| | | proportions by | Critical | respect |
| | | volume in the dry | load | to the |
| Substrate | Colloidal silica | primer coating | (daN) | reference |
| CR39 | Reference (without silica) | | 156 | — |
| CR39 | Cataloid Si30 ® | 30/70 | 183 | 17% |
| CR39 | Cataloid Si30 ® | 37/63 | 177 | 13% |
| CR39 | Cataloid Si30 ® | 43/57 | 185 | 19% |
| CR39 | Reference (without silica) | | 135 | — |
| CR39 | Bindzil CC40 ® | 30/70 | 157 | 16% |
| CR39 | Bindzil CC40 ® | 37/63 | 150 | 11% |
| CR39 | Bindzil CC40 ® | 43/57 | 162 | 20% |

The results of table 1 are represented in FIG. 1.

It is found, with a CR39 substrate and a Crizal Aliz\acute{0}® antireflective coating, that the replacement of 30%, 37% or 43% by volume of the polyurethane with particulate silica originating from Cataloid Si30® colloidal silica in the dry primer coating results in an increase in crack resistance of the antireflective coating of 17%, 13% and 19% respectively.

It is found, with a CR39 substrate and a Crizal Alizé® antireflective coating, that the replacement of 30%, 37% or 43% by volume of polyurethane with particulate silica originating from Bindzil CC40® colloidal silica in the dry primer coating results in an increase in crack resistance of the antireflective coating of 16%, 11% and 20% respectively.

Furthermore, the presence of particulate silica in the primer coating does not detrimentally affect either the adhesion or the abrasion resistance of the abrasion-resistant coating.

The results of the test carried out on an ophthalmic lens with substrate made of MR7® and Crizal Alizé® antireflective coating are shown in table 2:

TABLE 2

| | Primer coating | | | |
|---|---|---|---|---|
| | | Ratio between the | | Increase in |
| | | silica/ | | resistance |
| | | polyurethane | | with |
| | | proportions by | Critical | respect |
| | | volume in the dry | load | to the |
| Substrate | Colloidal silica | primer coating | (daN) | reference |
| MR7 | Reference (without silica) | | 140 | — |
| MR7 | Bindzil CC40 ® | 30/70 | 173 | 24% |
| MR7 | Bindzil CC40 ® | 37/63 | 168 | 20% |
| MR7 | Bindzil CC40 ® | 43/57 | 180 | 29% |

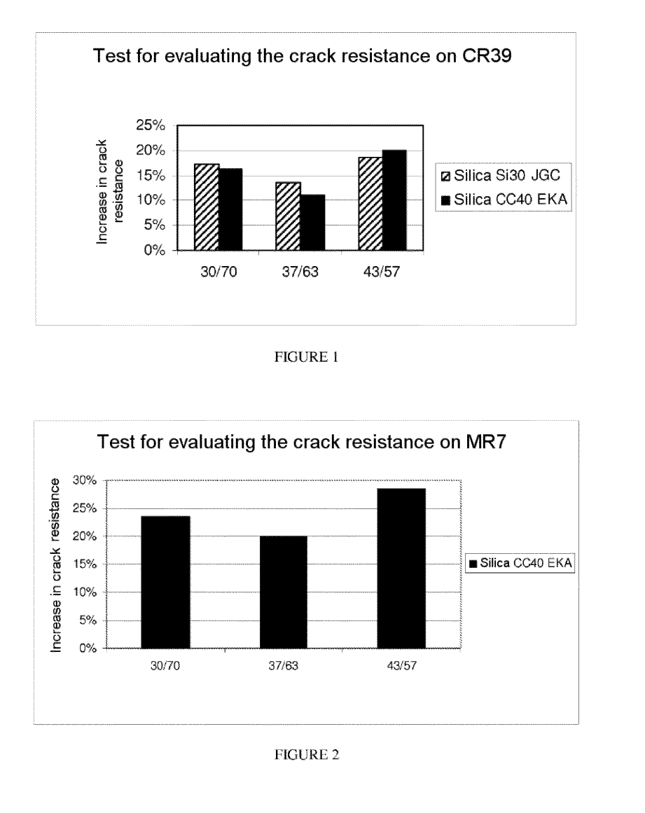

The results of table 2 are represented in FIG. 2.

It is found, with an MR7® substrate and a Crizal Alizé® antireflective coating, that the replacement of 30%, 37% or 43% by volume of polyurethane with particulate silica originating from Bindzil CC40® colloidal silica in the dry primer coating results in an increase in crack resistance of the antireflective coating of 24%, 20% and 37% respectively.

Furthermore, the presence of particulate silica in the primer coating does not detrimentally affect either the adhesion or the abrasion resistance of the abrasion-resistant coating.

These results thus confirm that the addition of colloidal silica to the primer coating makes it possible to increase the crack resistance of the antireflective coating when the optical article is subjected to mechanical stresses, without detrimentally affecting the adhesion or the abrasion resistance of the abrasion-resistant coating.

### 2) Impact Strength

2.1) Method:

The impact strength of the lenses is evaluated according to the standard ANSI Standard Z 80.1-1987, by dropping an impactor at the center of the convex face of each glass. This test is commonly called the ball drop (BAD) test. The change in the acceleration of the impactor during contact with the glass makes it possible to determine the fracture energy of the glass. The mean fracture energy (FEₘₑₐₙ in mJ) and the minimum fracture energy (FEₘᵢₙᵢ) are determined for each series of glasses (n=20-40).

The minimum limit for FDA (Food and Drug Administration) conformity lies at a fracture energy value equal to 200 mJ.

2.1) Results:

The tested lens comprises, on each of its two faces (front and back), starting from the substrate: a primer coating comprising polyurethane and Cataloid Si30® particulate silica, an abrasion-resistant layer having a polysiloxane matrix comprising colloidal silica, and an antireflective layer. The samples used were produced in the way described in point 1.2 above for stages A) to C). Depending on the samples and only when this is mentioned, stage D) was replaced by a stage D′) in which an antistatic layer made of indium tin oxide (ITO) is deposited in the antireflective stack. If not, stage D was adhered to.

The results of the BAD test carried out on an ophthalmic lens with substrate made of CR39® or MR7® are shown in table 1 below.

TABLE 1

| | | Fracture energy (mJ) at | | |
|---|---|---|---|---|
| | | different proportions of silica | | |
| | | in the primer | | |
| | | Ratio between | | |
| | | the silica/polyurethane | | |
| | | proportions by volume in the | | |
| | | dry primer coating | | |
| Substrate | Antireflective layer | 30/70 | 37/63 | 43/57 |
| MR7 | Crizal Alizé ® | 1500 | 1303 | 1207 |
| CR39 | Coating similar to | 250 | | |
| | Crizal Alizé ® | | | |
| | (additional presence of | | | |
| | an ITO antistatic | | | |
| | layer) | | | |

With an MR7 substrate, it is found that the impact strength decreases if the amount of particulate silica in the primer coating is increased.

With a CR39 substrate, it is found that, with a primer in which the ratio between the silica/polyurethane proportions by volume is 30/70, the fracture energy according to the BAD test is 250 mJ, i.e. slightly above the minimum value required by the FDA. The existence of a significant difference in performance between the samples comprising a substrate made of MR7 and those having a substrate made of CR39 is known to a person skilled in the art. Specifically, the use of the material MR7 to form the substrate makes it possible, because of its intrinsic mechanical properties, to obtain a better impact strength than by using the material CR39.

By combining these two teachings, it appears that an increase in the amount of silica in a primer used on a substrate made of CR39 would result in the formation of ophthalmic lenses having impact resistance values very close to the limit set by the FDA and potentially lower. Thus, the primer composition in which the ratio between the silica/polyurethane proportions by volume is 30/70 appears as optimum if it is desired for the impact strength to be in accordance with the standards of the FDA, whatever the substrate (CR39 or MR7).

### 3) Variation in the Impact Strength and Crack Resistance of the Antireflective Coating as a Function of the Proportion of Particulate Silica Present in the Primer Coating

FIG. 3 represents the impact strength of the antireflective coating as a function of the proportion of particulate silica in the primer coating (substrate: CR39; abrasion-resistant layer having a polysiloxane matrix comprising colloidal silica; antireflective layer: coating similar to Crizal Alizé® with additional presence of an ITO antistatic layer). The layers are applied as described above in point 1.2.

The impact strength is regarded as significantly modified above a difference of 100 mJ.

Conclusion: the results indicated in FIG. 3 show that the primer coating comprising from 13% to 23% by volume of particulate silica makes it possible to confer, on the antireflective layer, an impact strength of the same order as that which comprises 30% by volume of particulate silica. In particular, the samples in which the primer coating comprises 23% by volume of particulate silica in the dry coating have the lowest impact strength performance, close to the FDA limit but always above it.

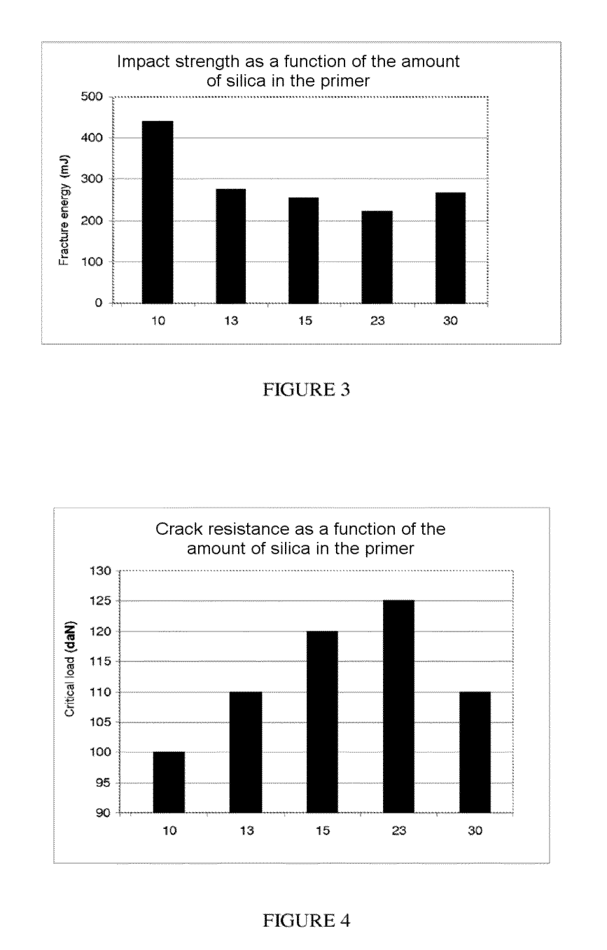

FIG. 4 represents the crack resistance of the antireflective coating as a function of the proportion of particulate silica in the primer coating (substrate: MR7; abrasion-resistant layer having a polysiloxane matrix comprising colloidal silica; antireflective layer: Crizal Forte®). The layers are applied as described above in point 1.2.

Conclusion: the results indicated in FIG. 4 show that the primer coating comprising from 13% to 23% by volume of particulate silica makes it possible to confer, on the antireflective layer, a crack resistance at least equal to that which comprises 30% by volume of particulate silica. In particular, the samples in which the primer coating comprises 15% or 23% by volume of particulate silica in the dry coating have crack resistance performances of the antireflective coating which are superior to the sample which comprises 30% by volume of particulate silica.

By combining these two analyses, the inventors anticipate that the best compromise in performance between the crack resistance of the antireflective coating and the impact strength according to the ball drop (BAD) test described above can be obtained with a percentage by volume of particulate silica of between 10% and 35%, more preferably between 12% and 35% and in particular between 12% and 15% and in the vicinity of 30%, for example between 25% and 35%, with respect to the volume of dry coating.

The invention will be further described by the following numbered paragraphs:
1. An optical article comprising, in the following order, starting from the substrate:

(a) a transparent substrate made of organic glass comprising two main faces,

(b) a primer coating comprising polyurethane, deposited on at least one of the two main faces of the substrate made of glass,

(c) an abrasion-resistant coating deposited on the primer coating, and

(d) an antireflective coating deposited on the abrasion-resistant coating, wherein the primer coating additionally comprises particulate silica.
2. The optical article as paragraphed in paragraph 1, wherein the percentage by weight of particulate silica in the dry primer coating is between 20% and 70%, preferably between 35% and 65% and more preferably between 45% and 55%, with respect to the weight of dry coating.
3. The optical article as paragraphed in paragraph 1, wherein the mean size of the silica particles is between 5 nm and 50 nm, preferably between 5 nm and 15 nm and more preferably between 7 nm and 12 nm.
4. The optical article as paragraphed in paragraph 1, wherein the percentage by weight of polyurethane in the dry primer coating is between 30% and 80%, preferably between 35% and 65% and more preferably between 45% and 55%, with respect to the weight of dry coating.
5. The optical article as paragraphed in paragraph 1, wherein the percentage by volume of particulate silica in the dry primer coating is between 10% and 50%, preferably between 20% and 40% and more preferably between 25% and 35%, with respect to the volume of dry coating.
6. The optical article as paragraphed in paragraph 1, wherein the ratio by weight of the particulate silica to the polyurethane in the dry primer coating is between 0.2 and 2.5, preferably between 0.5 and 1.5 and more preferably between 0.9 and 1.1.
7. The optical article as paragraphed in paragraph 1, wherein the thickness of the primer coating is between 0.2 and 2.5 μm, preferably between 0.5 and 1.5 μm and more preferably still between 0.5 and 1 μm.
8. The optical article as paragraphed in paragraph 1, wherein it exhibits a refractive index of 1.5.
9. A process for the manufacture of an optical article comprising the following stages:

(1) providing a substrate made of glass comprising two main faces;

(2) depositing, on at least one of the two main faces, a layer of a liquid primer composition comprising a polyurethane dispersion and colloidal silica, and then curing said primer composition, so as to obtain a primer coating;

(3) depositing an abrasion-resistant coating on the primer coating;

(4) depositing an antireflective coating on the abrasion-resistant coating.
10. The manufacturing process as paragraphed in paragraph 9, wherein stage (2) is carried out in the following way:

(a) on the substrate, application of a layer of a liquid primer composition comprising a polyurethane dispersion and colloidal silica;

(b) drying the substrate obtained in stage (1) at a temperature of between 50° C. and 150° C., preferably between 70° C. and 110° C., for a period of time of between 2 minutes and 4 hours, preferably between 10 minutes and 3.5 hours.
11. An optical article capable of being obtained according to the process as defined in paragraph 9 or 10.
12. A method for enhancing the crack resistance of an antireflective coating in an optical article comprising, in the following order, starting from the substrate:

(a) a substrate made of glass comprising two main faces,

(b) a primer coating comprising polyurethane, deposited on at least one of the two main faces of the substrate made of glass,

(c) an abrasion-resistant coating deposited on the primer coating, and

(d) an antireflective coating deposited on the abrasion-resistant coating, when said optical article is subjected to mechanical stresses,

which comprises introducing particulate silica into said primer coating.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

1. An optical article comprising, in the following order, starting from the substrate:
(a) a transparent substrate made of organic glass comprising two main faces,
(b) a primer coating comprising polyurethane, deposited on at least one of the two main faces of the substrate made of glass,
(c) an abrasion-resistant coating deposited on the primer coating, and
(d) an antireflective coating deposited on the abrasion-resistant coating,
wherein the primer coating additionally comprises particulate silica.

2. The optical article as claimed in claim 1, wherein the percentage by weight of particulate silica in the dry primer coating is between 20% and 70%, preferably between 35% and 65% and more preferably between 45% and 55%, with respect to the weight of dry coating.

3. The optical article as claimed in claim 1, wherein the mean size of the silica particles is between 5 nm and 50 nm, preferably between 5 nm and 15 nm and more preferably between 7 nm and 12 nm.

4. The optical article as claimed in claim 1, wherein the percentage by weight of polyurethane in the dry primer coating is between 30% and 80%, preferably between 35% and 65% and more preferably between 45% and 55%, with respect to the weight of dry coating.

5. The optical article as claimed in claim 1, wherein the percentage by volume of particulate silica in the dry primer coating is between 10% and 50%, preferably between 20% and 40% and more preferably between 25% and 35%, with respect to the volume of dry coating.

6. The optical article as claimed in claim 1, wherein the weight ratio of the particulate silica to the polyurethane in the dry primer coating is between 0.2 and 2.5, preferably between 0.5 and 1.5 and more preferably between 0.9 and 1.1.

7. The optical article as claimed in claim 1, wherein the thickness of the primer coating is between 0.2 and 2.5 μm, preferably between 0.5 and 1.5 μm and more preferably still between 0.5 and 1 μm.

8. The optical article as claimed in claim 1, wherein it exhibits a refractive index of 1.5.

9. A process for the manufacture of an optical article comprising the following stages:
(1) providing a substrate made of organic glass comprising two main faces;
(2) depositing, on at least one of the two main faces, a layer of a liquid primer composition comprising a polyurethane dispersion and colloidal silica, and then curing said primer composition, so as to obtain a primer coating;
(3) depositing an abrasion-resistant coating on the primer coating;
(4) depositing an antireflective coating on the abrasion-resistant coating.

10. The manufacturing process as claimed in claim 9, wherein stage (2) is carried out in the following way:
(a) on the substrate, application of a layer of a liquid primer composition comprising a polyurethane dispersion and colloidal silica;
(b) drying the substrate obtained in stage (1) at a temperature of between 50° C. and 150° C., preferably between 70° C. and 110° C., for a period of time of between 2 minutes and 4 hours, preferably between 10 minutes and 3.5 hours.

11. An optical article capable of being obtained according to the process as defined in claim 9 or 10.

12. A method for enhancing the crack resistance of an antireflective coating in an optical article comprising, in the following order, starting from the substrate:
(a) a substrate made of organic glass comprising two main faces,
(b) a primer coating comprising polyurethane, deposited on at least one of the two main faces of the substrate made of glass,
(c) an abrasion-resistant coating deposited on the primer coating, and
(d) an antireflective coating deposited on the abrasion-resistant coating,
when said optical article is subjected to mechanical stresses,
which comprises introducing particulate silica into said primer coating.
